(19) United States
(12) Patent Application Publication
(10) Pub. No.: US 2006/0187316 A1
(43) Pub. Date: Aug. 24, 2006

(54) Image capturing apparatus

(75) Inventors: Tougo Teramoto, Wakayama-shi (JP); Shinichi Ban, Kobe-shi (JP); Katsuyuki Nanba, Sakai-shi (JP); Toshihiro Hamamura, Yokohama-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/242,450

(22) Filed: Oct. 3, 2005

(30) Foreign Application Priority Data
Feb. 21, 2005 (JP) JP2005-044223

(51) Int. Cl. H04N 5/76

(52) U.S. Cl. 348/231.3

(57) ABSTRACT

When the IC tag starts communication with an external device, which one of an image capturing mode and a playback mode is selected is determined. In the case where it is determined that the image capturing mode is selected, the IC tag is covered with a slide cover to thereby prohibit the IC tag from communicating with the external device. Since the radio communication with the external device of the IC tag becomes impossible by the prohibition, an influence of an electric wave of radio communication exerted on a captured image at the time of image capturing can be avoided.

This application is based on application No. 2005-044223 filed in Japan, the contents of which are hereby incorporated by reference.

### BACKGROUND OF THE INVENTION

1. Field of the Invention

The present invention relates to an image capturing apparatus provided with an IC tag.

2. Description of the Background Art

In recent years, as a commodity identifying or managing technique replacing a bar code, a radio frequency identification (RFID) tag (an IC tag) is being practically used. The RFID tag stores information such as identification (ID) number and price of an object to which the RFID tag is attached and, when an electric wave transmitted from an RFID tag reader/writer is received, transmits the information stored in the RFID tag.

As an example of a technique using such an RFID tag, a technique is proposed in which at the time of capturing an image of a subject having an RFID tag by using an image capturing apparatus (digital camera), subject information in the RFID tag is acquired (see Japanese Patent Application Laid-Open No. 2003-174578).

In the conventional technique, the RFID tag is provided on the subject side. In contrast, it can be also considered that the RFID tag is provided on the image capturing apparatus side and information of the image capturing apparatus is transmitted so as to be used for authentication at the time of connection to a network or the like.

When the RFID tag is provided on the image capturing apparatus side, however, a problem occurs such that radio communication performed between the RFID tag reader/writer and the RFID tag may exert an influence on a captured image.

### SUMMARY OF THE INVENTION

An object of the present invention is to provide an image capturing apparatus in which communication performed between an external device and an IC tag does not exert an influence on a captured image.

In order to achieve the object, according to a first aspect of the present invention, an image capturing apparatus comprises: an IC tag in which predetermined information is stored; a processor for performing a predetermined process in an image capturing operation; and a prohibiting member for prohibiting the IC tag from performing communication with an external device during operation of the processor.

Since the image capturing apparatus can prohibit communication between the external device and the IC tag during the period of the predetermined process in the image capturing operation, an influence on a captured image of the communication can be avoided.

In order to achieve the object, according to a second aspect of the present invention, an image capturing apparatus comprises: an IC tag in which predetermined information is stored; a processor for performing a predetermined process in an image capturing operation; and a controller for prohibiting the IC tag from performing communication with an external device during operation of the processor.

Since the image capturing apparatus can prohibit communication between the external device and the IC tag during the period of the predetermined process in the image capturing operation, an influence on a captured image of the communication can be avoided.

In order to achieve the object, according to a third aspect of the present invention, an image capturing apparatus comprises: an IC tag in which predetermined information is stored; a switching member for switching between an image capturing mode of capturing an image of a subject and a playback mode of reproducing a captured image of a subject; and a controller for prohibiting the IC tag from performing communication with an external device when the image capturing mode is set by the switching member.

Since the image capturing apparatus can prohibit communication between the external device and the IC tag when the image capturing mode is set, an influence on a captured image of the communication can be avoided.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing an outside configuration in an image capturing state of an image capturing apparatus according to a first preferred embodiment of the present invention;

FIG. 2 is a perspective view showing an outside configuration in a non-image-capturing state of the image capturing apparatus according to the first preferred embodiment;

FIG. 3 is a block diagram showing a functional configuration of the image capturing apparatus according to the first preferred embodiment;

FIG. 4 is a plan view showing the configuration of an RFID tag (an IC tag) of a passive type.

FIG. 5 is a diagram showing an example of tag information held in the RFID tag of the passive type;

FIG. 6 is a plan view showing the configuration of an RFID tag of an active type;

FIG. 7 is a diagram showing an example of tag information held in the RFID tag of the active type;

FIG. 8 is a flowchart showing operations of the image capturing apparatus;

FIG. 9 is a perspective view showing an outside configuration of an image capturing apparatus according to a second preferred embodiment of the present invention; and

FIG. 10 is a flowchart in an image capturing operation state of the image capturing apparatus according to the second preferred embodiment.

### DESCRIPTION OF THE PREFERRED EMBODIMENTS

Preferred embodiments of the present invention will be described below with reference to the drawings.

### 1. First Preferred Embodiment

Apparatus Configuration

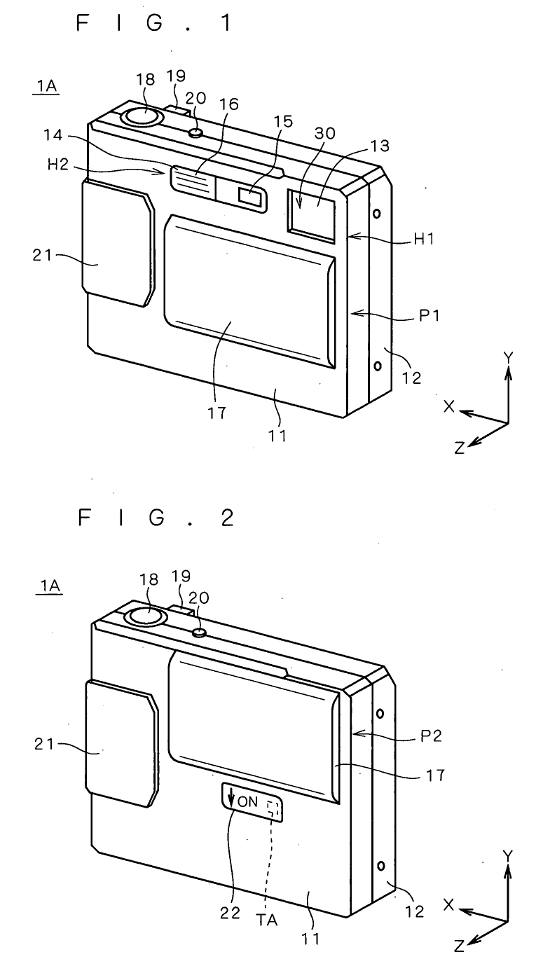

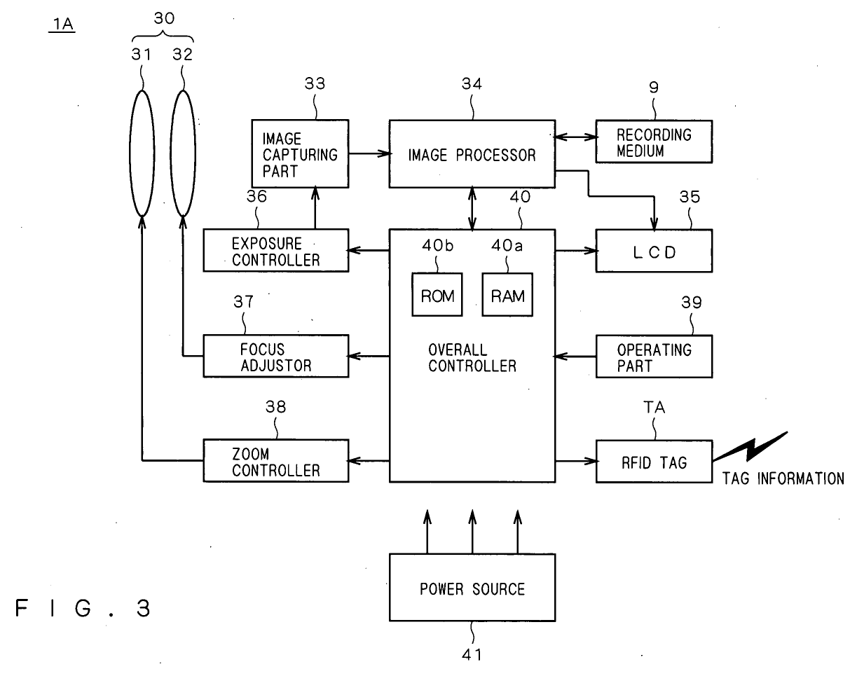

FIGS. 1 and 2 are perspective views each showing an outside configuration of an image capturing apparatus 1A according to a first preferred embodiment of the present invention. FIG. 1 shows an image capturing (image capturing operation) state, and FIG. 2 shows a non-image-capturing (reproducing operation) state.

The image capturing apparatus 1A is constructed, for example, as a digital camera, and its casing is formed by a front cover 11 and a rear cover 12.

The front cover 11 has two openings H1 and H2. The opening H1 is provided to guide an image from a subject to a taking lens 30. For example, a transparent window 13 made of plastic is fit in the opening H1. Similarly, for example, a transparent window 14 made of plastic is fit in the opening H2. On the inside of the window 14, a viewfinder 15 and an electronic flash 16 are provided in parallel.

The front cover 11 has a metal slide cover 17 which can slide in a Y direction. In the image capturing state, the slide cover 17 is disposed in an image capturing position P1 (see FIG. 1) in which the openings H1 and H2 are not shielded, and the image capturing apparatus 1A can perform image capturing operation. On the other hand, in the non-image-capturing state, the slide cover 17 is disposed in a non-image-capturing position P2 (see FIG. 2) higher than the image capturing position P1 and shields the openings H1 and H2.

When the slide cover 17 moves from the image capturing position P1 to the non-image-capturing position P2, a seal 22 attached to the front cover 11 is exposed. On the rear face of the seal 22, an RFID tag (an IC tag) TA which will be described later is provided. By providing the RFID tag TA in the position where the seal 22 exists, the slide cover 17 positioned in the image capturing position P1 in the image capturing operation state functions as a shield member shielding the RFID tag TA. When the slide cover 17 is positioned in the non-image-capturing position P2, the RFID tag TA is not shielded, so that communication with an external device by the RFID tag TA can be performed.

In a side face of the image capturing apparatus 1A, a grip 21 used by a user to grasp the image capturing apparatus 1A is provided. The grip 21 also functions as a cover for covering a battery space in the image capturing apparatus 1A in which a battery is attached.

FIG. 3 is a block diagram showing a functional configuration of the image capturing apparatus 1A.

In the image capturing apparatus 1A, a subject image (an optical image of a subject) enters an image capturing part 33 via the taking lens 30 provided at the back of the window 13. The taking lens 30 has a zoom lens 31 and a focus lens 32.

The subject image entered the image capturing part 33 is converted to an electric signal (image signal) by a photoelectric conversion function of an image pickup device (for example, CCD) (not shown) in the image capturing part 33. The electric signal is A/D converted in the image capturing part 33, thereby becoming image data. In short, the image capturing part 33 constructed by the image pickup device (CCD) and the like has the function of performing an image capturing process (image data generating process) of capturing a subject image and generating (acquiring) image data.

Further, the image data generated in the image capturing part 33 is subjected to image processes such as a white balance correction process, a y correction process and a color correction process in an image processor 34. After that, the processed image data is written onto a recording medium 9 at a predetermined timing, and also displayed as an image for live-view display on an LCD 35.

A zoom controller 38 has the function of driving the zoom lens 31 in accordance with an instruction of an operator (user) or the like to change the focal length. A focus adjustor 37 has the function of driving the focus lens 32 to achieve focus on a subject.

An exposure controller 36 has the function of performing an exposure control by adjusting an aperture and exposure time of the image pickup device (CCD) in the image capturing part 33, thereby adjusting a captured image to have proper brightness.

An operating part 39 is constructed by buttons, switches and the like which can be operated by the user, and includes a power switch 20, a release button 18 (release switch) used by the user to instruct an image capturing timing, a changeover switch 19 for switching between an image capturing mode and a playback mode, and the like. The image capturing mode (hereinafter, also referred to as “image capturing operation state”) is a mode of capturing an image of a subject and generating image data. The playback mode (hereinafter, also referred to as “reproduction operation state”) is a mode of reproducing the image data recorded on the recording medium 9 and displaying it on the LCD 35.

A power source 41 used as a power supply source supplies operation power to each of the components of the image capturing apparatus 1A such as an overall controller 40.

The overall controller 40 is constructed by a microcomputer having therein a RAM 40a and a ROM 40b and has the function of controlling the above components in a centralized manner by executing a control program prestored in the ROM 40b by a microcomputer.

RFID Tag

The RFID tag TA will now be described. RFID tags can be an RFID tag of a passive type (hereinafter, also referred to as RFID tag T1) and an RFID tag of an active type (hereinafter, also referred to as RFID tag T2) which have different drive characteristics. Each of the RFID tag T1 of the passive type and the RFID tag T2 of the active type will be described in detail below.

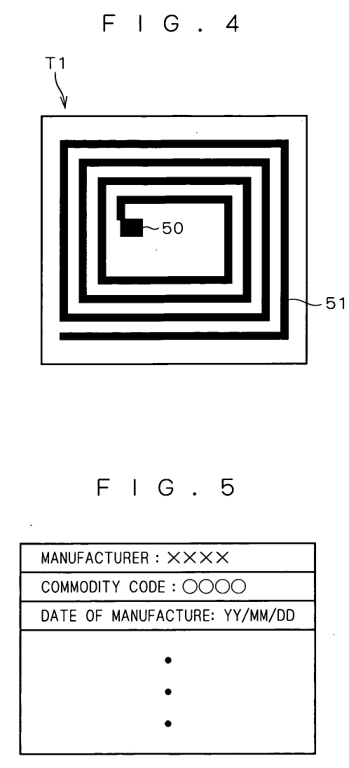

FIG. 4 is a plan view showing the configuration of the RFID tag T1 of the passive type. FIG. 5 is a diagram showing an example of information held in the RFID tag T1 (hereinafter, also referred to as “tag information”).

As shown in FIG. 4, the RFID tag T1 has a memory 50 constructed as an IC chip and a spiral antenna 51. The memory 50 stores (records) information of the image capturing apparatus 1A as shown in FIG. 5 as tag information.

The RFID tag T1 is of a no-power type (passive type) which does not have therein a power supply source. Consequently, in the RFID tag T1, tag information in the memory 50 is transmitted by using energy of an electric wave transmitted from an external RFID tag reader for reading information of the RFID tag T1. The RFID tag T1 has generally a smaller amount of information and a shorter communication distance as compared with the RFID tag T2 that will be described later. Therefore, for example, only product information of the image capturing apparatus 1A is extracted and stored so as to include the minimum information necessary for identifying the image capturing apparatus 1A (FIG. 5).

On the other hand, the RFID tag T1 can transmit/receive information by power supply using electric waves from the RFID tag reader irrespective of the state of the image capturing apparatus 1A. Consequently, also in the case where the image capturing apparatus 1A is broken and does not start, tag information and the like (FIG. 5) of the image capturing apparatus 1A can be received by the RFID tag reader and used for services of repair and the like.

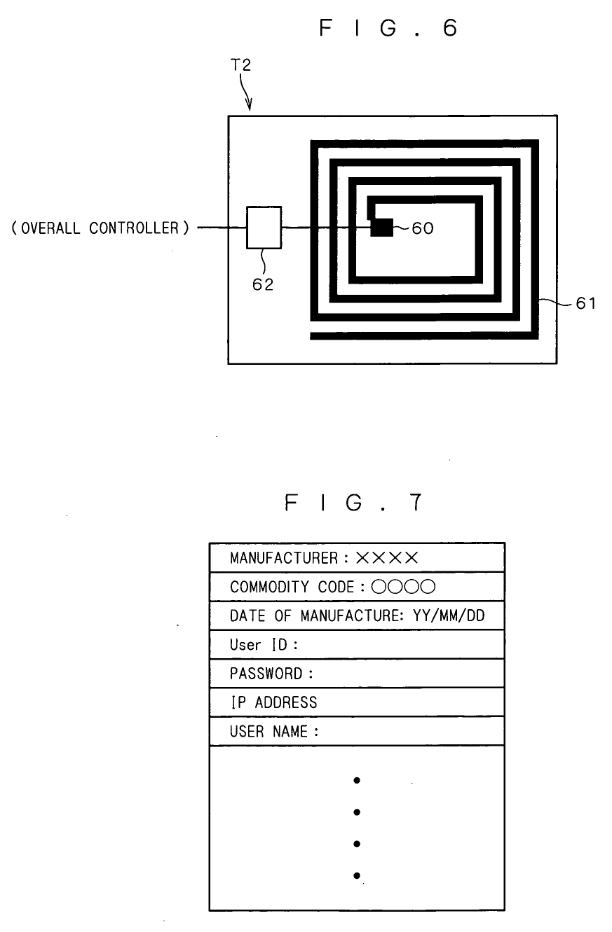

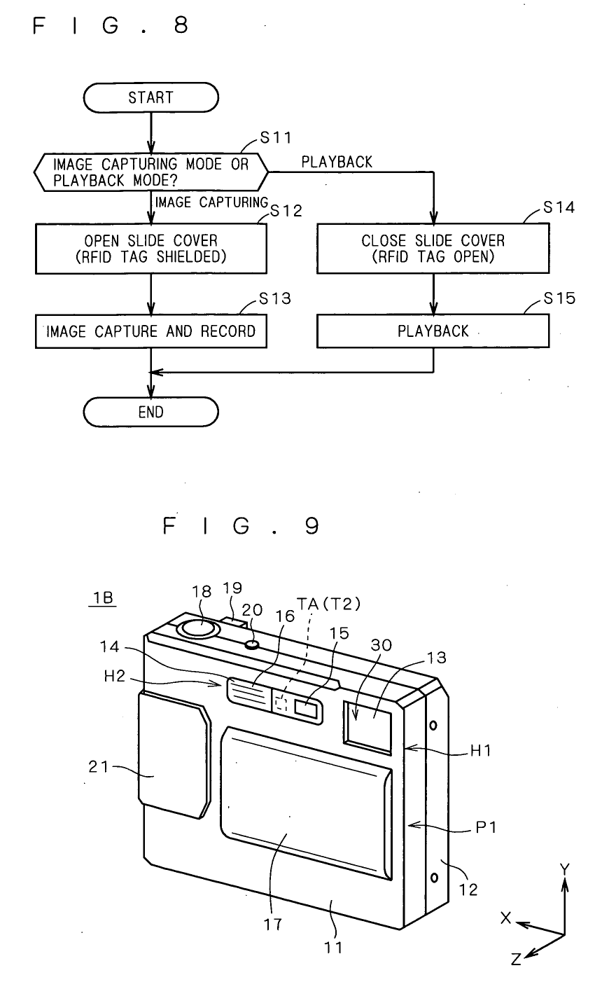

The RFID tag T2 of the active type will now be described. FIG. 6 is a plan view showing the configuration of the RFID tag T2 of the active type. FIG. 7 is a diagram showing an example of tag information held in the RFID tag T2 of the active type.

As shown in FIG. 6, the RFID tag T2 has a memory 60 constructed as an IC chip, and an antenna 61 similar to that of the RFID tag T1. The memory 60 stores, as tag information, information of the image capturing apparatus 1A or user information as shown in FIG. 7.

Further, the RFID tag T2 is constructed as an RFID tag of a battery-provided type (active type) having a power source 62 including a battery. Since the RFID tag T2 can receive power supply from the power source in the tag, the RFID tag T2 has advantages such as longer-distance communication and a larger amount of information stored in the memory 60 as compared with the RFID tag T1 of the type having therein no power source. By utilizing the advantages, the RFID tag T2 can record and transmit high-degree information required at the time of connection to a network or the like.

On receipt of an electric wave signal requiring transmission of tag information from an external device (for example, an RFID tag reader/writer), the RFID tag T2 transmits its tag information in accordance with the signal.

The power source 62 in the RFID tag T2 has an electric connection which receives a control signal from the overall controller 40. With the configuration, the image capturing apparatus 1A can select execution or inexecution of radio communication (hereinafter, also simply referred to as “communication”) by the RFID tag T2 by sending a predetermined control signal to the RFID tag T2 from the overall controller 40.

As described above, there are two kinds of the RFID tags TA of different characteristics. In the following, the operation of the image capturing apparatus 1A having the RFID tag T1 of the passive type on the back side of the seal 22 will be described.

Operation

FIG. 8 is a flowchart showing the operation of the image capturing apparatus 1A.

As shown in FIG. 8, the image capturing apparatus 1A determines which one of the image capturing operation state (image capturing mode) and the reproducing operation state (playback mode) is selected in accordance with a selection position of the changeover switch 19 (step S11).

In the case where it is determined in step S11 that the image capturing mode is selected, the slide cover 17 is moved to the image capturing position P1 (see FIG. 1) by a driving part (not shown) (step S12), and the image capturing apparatus 1A enters the image capturing operation state where it can capture an image. By disposing the slide cover 17 in the image capturing position P1, the RFID tag T1 is covered with the slide cover 17. Consequently, the RFID tag T1 enters a state where communication with an external device is prohibited.

More specifically, the RFID tag T1 of the passive type receives an electric wave from an external device and receives power supply by the received electric wave, thereby performing radio communication. Therefore, when the RFID tag T1 is shielded by being covered with the slide cover 17, an electric wave from the external device does not reach the RFID tag T1, and the RFID tag T1 cannot start radio communication with the external device. In other words, the RFID tag T1 is prohibited from performing communication with external devices.

When the release switch 18 is depressed by the operation of the user or the like in a state where the slide cover 17 is disposed in the image capturing position P1, image capturing operation is executed and a captured image is recorded on the recording medium 9 (step S13).

On the other hand, when it is determined in step S11 that the playback mode is selected, the slide cover 17 is moved to the non-image-capturing position P2 by the driving part (step S14), and the image capturing apparatus 1A enters the reproducing operation state in which image capturing operation cannot be performed (step S15). In the playback mode, when the slide cover 17 is disposed in the non-image-capturing position P2, the RFID tag T1 is exposed (open). Consequently, the RFID tag T1 can perform communication with an external device.

As described above, by covering the RFID tag T1 with the slide cover 17 to prohibit radio communication with an external device of the RFID tag T1 during a predetermined process (concretely, an image capturing process (image data generating process) and an image process) in the image capturing operation, an influence exerted on the captured image by electric waves of the radio communication can be avoided.

### 2. Second Preferred Embodiment

A second preferred embodiment of the present invention will now be described. In the following, points different from the first preferred embodiment will be mainly described. The same reference numerals are given to common parts and their description will not be repeated.

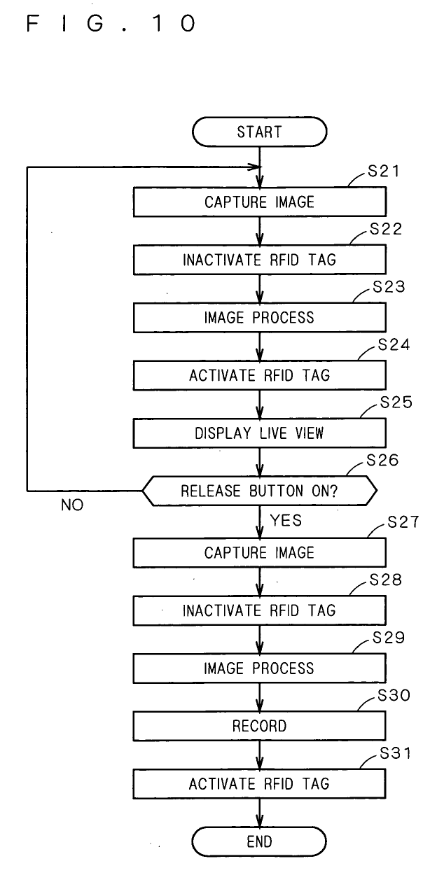

FIG. 9 is a perspective view showing an outside configuration of an image capturing apparatus 1B according to the second preferred embodiment of the present invention. The different point in configuration of the image capturing apparatus 1B shown in FIG. 9 from the image capturing apparatus 1A of the first preferred embodiment (see FIG. 1) is that the RFID tag TA of the image capturing apparatus 1B is provided between the viewfinder 15 and the electronic flash 16 in the opening H2.

It is assumed that the RFID tag TA in the first preferred embodiment is an RFID tag T1 of the passive type. In the second preferred embodiment, it is assumed that the RFID tag TA is an RFID tag T2 of the active type.

FIG. 10 is a flowchart in the image capturing operation state of the image capturing apparatus 1B.

As shown in FIG. 10, first, in step S21, image data for live-view display is acquired by an image capturing process (image data generating process). Concretely, a subject image incident on the image capturing part 33 is converted to an electric signal (image signal) by the image pickup device (CCD) in the image capturing part 33 and, further, the electric signal is A/D converted to image data in the image capturing part 33.

After the image data for live-view display is generated in the image capturing process of step S21, by making the RFID tag TA (RFID tag T2) inactive, communication with an external device (RFID tag reader) performed by the RFID tag T2 is prohibited (step S22). Concretely, the image capturing apparatus 1B has an electric connection from the overall controller 40 to the power source 62 in the RFID tag T2. According to a control signal using the connection, either execution (activation) or inexecution (inactivation) of radio communication performed by the RFID tag T2 can be selected. Specifically, in step S22, the image capturing apparatus 1B sends a control signal to inactivate radio communication (hereinafter, also referred to as an inactivate control signal) from the overall controller 40 to the RFID tag T2, thereby making the RFID tag T2 inactive and making communication with an external device impossible. The inactive state may be a state where power supply to the RFID tag T2 is stopped or a state where even an electric wave signal requiring transmission of tag information is received from the RFID tag reader, no reply is sent.

When radio communication of the RFID tag T2 is prohibited in step S22, the image data for live-view display captured by the image capturing part 33 is subjected to predetermined image processes in the image processor 34 (step S23). More specifically, the image data captured in step S21 is subjected to the white balance correction process, the γ correction process, the color correction process and the like in the image processor 34.

After the predetermined image processes are finished, the image capturing apparatus 1B sends a control signal to activate radio communication (hereinafter, also referred to as activate control signal) to the power source 62 of the RFID tag T2. The RFID tag T2 is activated so that radio communication with an external device can restart (step S24).

The image data subjected to the predetermined image processes in step S23 is displayed as a live-view image on the LCD 35 (step S25).

Next, whether the release switch 18 is ON or not is determined (step S26). When it is determined that the release switch 18 is not ON, the program returns to step S21 where the image capturing operation for a live-view image is performed again. On the other hand, when it is determined that the release switch 18 is ON, the program advances to step S27 where an image capturing operation or the like is performed.

Concretely, first, image data for image capturing operation is generated by using the image pickup device or the like (step S27).

After image data for the image capturing operation is generated, by making the RFID tag T2 inactive, communication with an external device is prohibited (step S28). Concretely, a process similar to that performed in step S22 is executed. To be specific, the image capturing apparatus 1B makes the RFID tag T2 inactive by sending a control signal for inactivating radio communication (inactivate control signal) from the overall controller 40 to the RFID tag T2, thereby making communication with an external device impossible.

When radio communication with the RFID tag T2 is prohibited in step S28, an image process similar to that performed in step S23 is performed by the image processor 34 on the image data for image capturing which is captured in the image capturing part 33, thereby generating an image to be recorded (captured image) (step S29).

The captured image generated in step S29 is recorded on the recording medium 9 (step S30).

After recording of the captured image to the recording medium 9 is finished in step S30, the image capturing apparatus 1B sends a control signal for restarting the radio communication of the RFID tag T2 (activate control signal) to the power source 62. By the control signal, the RFID tag T2 is activated so that radio communication with an external device can restart (step S31).

As described above, by prohibiting radio communication of the RFID tag T2 by the control signal from the overall controller 40 during the image process in the image capturing operation state and during recording of the captured image to the recording medium 9, an influence exerted on the captured image by the electric wave of the radio communication can be avoided.

### 3. Modifications

Although the preferred embodiments of the present invention have been described above, the present invention is not limited to these preferred embodiments.

For example, in the first preferred embodiment, it is assumed that the RFID tag TA provided for the image capturing apparatus 1A is the RFID tag T1 of the passive type. However, the present invention is not limited thereto. Concretely, the RFID tag TA may be the RFID tag T2 of the active type. When the RFID tag T2 is shielded by being covered with the slide cover 17, a state where an electric wave from an external device does not reach the RFID tag T2 is obtained, and the RFID tag T2 cannot start radio communication by reception of an electric wave from an external device. In other words, the RFID tag T2 is prohibited from performing communication with an external device.

As described above, by prohibiting the RFID tag T2 from performing the radio communication with an external device by covering the RFID tag T2 with the slide cover 17 in the image capturing operation state, an influence exerted on a captured image during a predetermined process such as the image capturing process (image data generating process) or an image process or the like by the electric wave of radio communication can be avoided.

In the second preferred embodiment, radio communication of the RFID tag T2 is prohibited only during the image process and recording of a captured image to the recording medium 9. However, the present invention is not limited thereto. Concretely, during the image capturing process, that is, at the time of performing the image capturing process (image data generating process) in step S21 or S27 in FIG. 10, communication between the RFID tag T2 and an external device may be prohibited. Thus, an influence exerted on the image capturing process by an electric wave of radio communication can be suppressed.

Alternatively, during the image capturing operation, communication with an external device performed by the RFID tag T2 may be always prohibited. Concretely, when it is determined that the image capturing mode is selected by an operation on the changeover switch 19 or the like performed by the user, it is sufficient to always make the RFID tag T2 inactive by a control signal of inexecuting communication from the overall controller 40 to prohibit communication with an external device performed by the RFID tag T2.

The RFID tag T2 of the active type in the foregoing preferred embodiments is not limited to the mode of receiving power supply from the power source in the tag but may receive power supply from the power source 41 in the image capturing apparatus 1A or 1B. For example, the RFID tag T2 may be made active or inactive in accordance with the presence/absence of power supply from the power source 41 in the image capturing apparatus 1B in the second preferred embodiment.

The mounting position of the RFID tag is not limited to those in the foregoing preferred embodiments. Concretely, the RFID tag TA in the first preferred embodiment may be disposed in any position where it is covered with the slide cover 17 or other shield members in the image capturing operation state. The RFID tag T2 in the second preferred embodiment may be disposed in position as long as it can be controlled by the overall controller 40.

In the first preferred embodiment, the user selects an operating state of the image capturing apparatus 1A by an operation on the change-over switch 19. Alternatively, the operation state of the image capturing apparatus 1A may be determined by manually moving the slide cover 17 to the image capturing position P1 or the non-image-capturing position P2.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus comprising:
an IC tag in which predetermined information is stored;
a processor for performing a predetermined process in an image capturing operation; and
a prohibiting member for prohibiting said IC tag from performing communication with an external device during operation of said processor.

2. The image capturing apparatus according to claim 1, wherein
the predetermined process performed by said processor includes a process of generating image data from an optical image of a subject by using an image sensor.

3. The image capturing apparatus according to claim 1, wherein
the predetermined process performed by said processor includes an image process on image data generated from an optical image of a subject.

4. The image capturing apparatus according to claim 1, wherein
said prohibiting member is a shield member.

5. The image capturing apparatus according to claim 1, wherein
said shield member is a lens cover which can be moved between a first position where a taking lens is covered with said shield member and a second position where the taking lens is exposed and, when the lens cover is in the second position, said communication is prohibited.

6. The image capturing apparatus according to claim 5, wherein
when said lens cover is in said second position, an image capturing mode of capturing an image of a subject is set and, when said lens cover is in said first position, a playback mode of reproducing a captured image of a subject is set.

7. The image capturing apparatus according to claim 5, wherein
said IC tag is disposed in a position where it is covered with the lens cover in said second position.

8. The image capturing apparatus according to claim 1, wherein
said IC tag has a memory storing at least information of the image capturing apparatus, and said IC tag transmits the information of the image capturing apparatus stored in the memory to said external device by communication.

9. An image capturing apparatus comprising:
an IC tag in which predetermined information is stored;
a processor for performing a predetermined process in an image capturing operation; and
a controller for prohibiting said IC tag from performing communication with an external device during operation of said processor.

10. The image capturing apparatus according to claim 9, wherein
the predetermined process performed by said processor includes a process of generating image data from an optical image of a subject by using an image sensor.

11. The image capturing apparatus according to claim 9, wherein
the predetermined process performed by said processor includes an image process on image data generated from an optical image of a subject.

12. The image capturing apparatus according to claim 9, wherein
said controller prohibits said communication by making said IC tag inactive.

13. The image capturing apparatus according to claim 12, wherein
said IC tag has a power source, and
said controller makes said IC tag inactive by stopping power supply from said power source.

14. The image capturing apparatus according to claim 9, wherein
said IC tag has a memory storing at least information of the image capturing apparatus, and said IC tag transmits the information of the image capturing apparatus stored in the memory to said external device by communication.

15. An image capturing apparatus comprising:
an IC tag in which predetermined information is stored;
a switching member for switching between an image capturing mode of capturing an image of a subject and a playback mode of reproducing a captured image of a subject; and
a controller for prohibiting said IC tag from performing communication with an external device when the image capturing mode is set by said switching member.

16. The image capturing apparatus according to claim 15, wherein
said controller prohibits said communication at least during a process of generating image data from an optical image of a subject by using an image sensor.

17. The image capturing apparatus according to claim 15, wherein
said controller prohibits said communication at least during an image process on image data generated from an optical image of a subject.

18. The image capturing apparatus according to claim 15, wherein
said IC tag has a memory storing at least information of the image capturing apparatus, and said IC tag transmits the information of the image capturing apparatus stored in the memory to said external device by communication.
